(19) United States
(12) Patent Application Publication
(10) Pub. No.: US 2007/0073659 A1
(43) Pub. Date: Mar. 29, 2007

(54) SYSTEM AND METHOD FOR NEGOTIATING TERM AND CONDITION ENTRIES OF A LEGAL DOCUMENT

(75) Inventors: Chung-I Lee, Tu-Cheng,Taipei Hsien (TW); Hai-Hong Lin, Shenzhen (CN); Xiao-Ping Zhang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,195

(22) Filed: Jul. 13, 2006

(30) Foreign Application Priority Data
Aug. 5, 2005 (CN) 200510036421.0

(51) Int. Cl. G06F 17/30

(52) U.S. Cl. 707/3

(57) ABSTRACT

The present invention provides a method for negotiating term and condition entries of a legal document. The method includes the steps of: setting contact information of users related to the legal document; displaying term and condition entries of the legal document; reviewing the term and condition entries; determining whether the term and condition entries are unanimously agreeable; reflecting opinions corresponding to the term and condition entries if the term and condition entries are not agreeable; informing the related users to negotiate the term and condition entries; modifying the term and condition entries according to the opinions; and creating a finalized legal document. A related system is also disclosed.

### FIELD OF THE INVENTION

The present invention relates to a system and method for negotiating term and condition entries of a legal document.

### DESCRIPTION OF RELATED ART

Modern complex commercial relationships involve multiple business partners and processes. This complexity affects term and condition entries corresponding terminologies on business liabilities, which relates to costs, shipments, payments, qualities, volume breaks, rebate policies, discounts, and so forth. Managing all of this (in particular if you have hosts of ever-changing partnerships) requires a serious commitment of time and resources. Today, a typical enterprise is required to communicate with a variety of vendors, suppliers, service providers, and such by using contracts, agreements, or other types of legal documents.

Legal documents are used in almost all areas of commerce. Most conventional legal documents are drafted and signed using an inefficient, manually irritating process. This can seriously affect the efficiency of the enterprise. Although in the past few years, enterprises started using legal document management software programs, however, these software programs lack functionalities that allow the enterprise to negotiate with a contractor regarding term and condition entries of the legal document efficiently.

What is needed, therefore, is a system and method that can provide an interface for the enterprise to negotiate with the suppliers on the term and condition entries of the legal documents efficiently, and can record all related data in negotiating process.

### SUMMARY OF THE INVENTION

A system for negotiating term and condition entries of a legal document is provided. The system includes a setting module, a displaying module, a negotiating module and an informing module. The setting module is configured for setting contact information of users related to the legal document. The displaying module is configured for displaying term and condition entries of the legal document, and for displaying a status of each term and condition entry. The negotiating module is configured for reflecting opinions of the users on the term and condition entries, for modifying the term and condition entries according to the opinions, and for creating a finalized legal document.

Furthermore, a method for negotiating term and condition entries of a legal document is provided. The method includes the steps of: setting contact information of users related to the legal document; displaying term and condition entries of the legal document; reviewing the term and condition entries; determining whether the term and condition entries are unanimously agreeable; reflecting opinions corresponding to the term and condition entries if the term and condition entries are not agreeable; informing the related users to negotiate the term and condition entries; modifying the term and condition entries according to the opinions; and creating a finalized legal document.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of a hardware configuration of a system for negotiating term and condition entries of a legal document in accordance with a preferred embodiment;

FIG. 2 is a schematic diagram of main software function modules of an application server of FIG. 1;

FIG. 3 is a flowchart of a method for negotiating term and condition entries of a legal document in accordance with a preferred embodiment; and

FIG. 4 is a schematic diagram of an exemplary legal document.

### DETAILED DESCRIPTION OF THE INVENTION

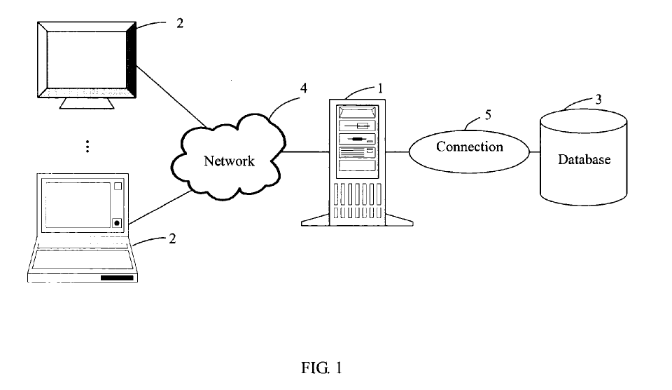

FIG. 1 is a schematic diagram of a hardware configuration of a system for negotiating term and condition entries of a legal document (hereinafter, “the system”) in accordance with a preferred embodiment. The system includes an application server 1, a plurality of clients 2 (only two shown), and a database 3. The application server 1 communicates with the clients 2 via a network 4. The network 4 may be an intranet, the Internet, or any other type of communication link. Each of the clients 2 is configured for providing an interactive interface enabling users to perform needed operations. For example, the users may reflect opinions regarding term and condition entries of legal documents stored in the database 3 and transmit the opinions to the application server 1 by using the interactive interface. The legal documents include contracts, agreements, and so on.

The application server 1 is configured for providing an administration interface to the clients 2, and for informing the users to negotiate or modify the term and condition entries of the legal documents.

The application server 1 is further connected with the database 3 via a connection 5. The database 3 is configured for storing legal documents, opinions reflected by the users, and other related data. The connection 5 is a database connectivity, such as an open database connectivity (ODBC) or a Java database connectivity (JDBC).

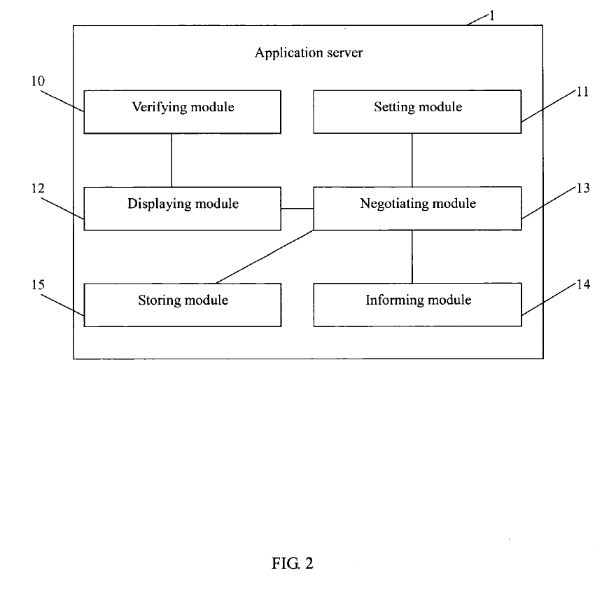

FIG. 2 is a schematic diagram of main software function modules of the application server 1. The application server 1 includes a verifying module 10, a setting module 11, a displaying module 12, a negotiating module 13, an informing module 14, and a storing module 15.

Since a finalized legal document is established through a cooperation between different users from different departments, such as a purchasing department, a financial department, a legal department, or any affiliates of an enterprise and a contracting party, the verifying module 10 is configured for granting access rights to corresponding privileged users according to requirements. For example, if a legal document relates to the financial department and the legal department of the enterprise, the verifying module 10 grants the access rights to corresponding privileged users from these two departments of the enterprise. The verifying module 10 is also configured for providing digital certificates for the privileged users. The digital certificates record identifications of the privileged users.

The verifying module 10 is further configured for setting a valid period of each digital certificate, for verifying the digital certificate when the privileged users log into the administration interface, and for determining whether the digital certificates are valid.

The setting module 11 is configured for setting contact information of users related to the legal document that needs to be negotiated, such as e-mail addresses, phone numbers, etc. The setting module 11 is further configured for adding or removing the related users according to requirements of the legal document.

The displaying module 12 is configured for displaying a list of legal documents. For example, after the privileged user logs into the administration interface by utilizing the digital certificate, the displaying module 12 displays a list of all legal documents that are responsible by the privileged user.

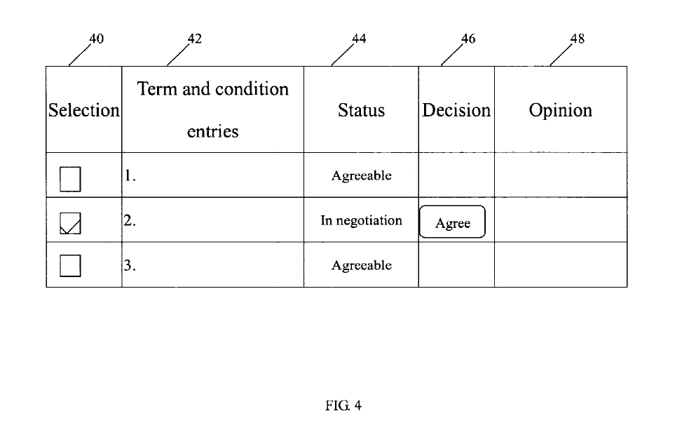

The displaying module 12 is also configured for displaying term and condition entries of the legal document, and for displaying a status of each term and condition entry. As shown in FIG. 4, an exemplary legal document has a status column 44 for displaying the status of each term and condition entry, a decision column 46 for providing clickable buttons for the related users, and an opinion column 48 for reflecting opinions. The statuses of all the term and condition entries are defaulted to display “agreeable”, unless modified by any privileged users. The displaying module 12 is further configured for updating the status of each term and condition entry in real time.

The negotiating module 13 is configured for reflecting opinions of the related users, and for providing an opinion-broadcast mode to the related users. The opinion-broadcast mode includes an internal mode and a public mode. For example, the related users within the enterprise are referred as internal users and the related users of the supplier are referred as external users. The internal mode is configured for broadcasting opinions only within the internal users, furthermore, any external users cannot view any opinions reflected in the internal mode. The public mode is configured for broadcasting opinions for both the internal users and the external users.

The negotiating module 13 is also configured for modifying the term and condition entries according to the opinions. The negotiating module 13 is further configured for limiting authorities of the related users. I.e., certain related users may only have the authority of viewing the term and condition entries and the opinions, but may not have the authority of reflecting new opinions. The displaying module 12 displays the opinions.

During negotiating, if any related users disagree on any of the term and condition entries, the status of the term and condition entry is updated to display “in negotiation” by the displaying module 12, and the corresponding decision column 46 provides the clickable buttons to be clicked by the related users, such as an “agree” button (described in detail below in relation to FIG. 4). The “agree” button is configured to be clickable by the related users after reviewing, negotiating, and modifying the term and condition entry as necessary. Finalizing the term and condition entry modified requires a unanimous decision; only when all the related users have clicked on the “agree” button will the status of the term and condition entry is updated to display “agreeable” and the term and condition entry is highlighted so as to be distinguishable amongst other term and condition entries.

The informing module 14 is configured for informing the related users by the contact information to view the opinions or to respond the opinions. For example, if the opinions are in the internal mode, the informing module 14 only informs the internal users to view the opinions. The internal users may be from the purchasing department and the legal department of the enterprise.

After modifying the term and condition entries according to the opinions, the negotiating module 13 is also configured for creating a finalized legal document. The finalized legal document is ready to be authorized and signed by managers of the enterprise and the supplier. The storing module 15 is configured for storing a variety of legal documents (e.g., legal documents that need to be negotiated, finalized legal documents, etc), term and condition entries, opinions and other related data.

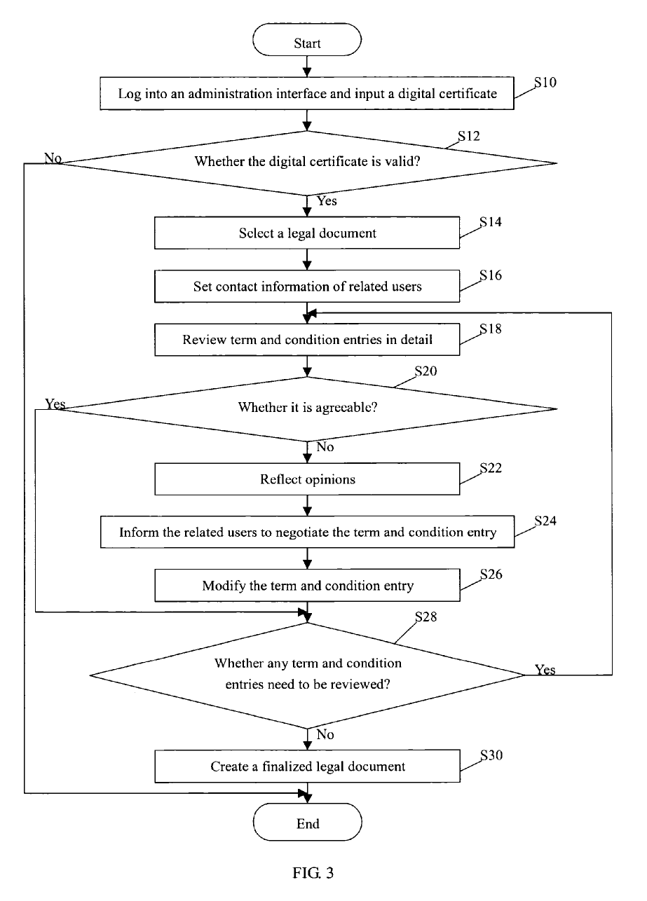

FIG. 3 is a flowchart of a method for negotiating term and condition entries of a legal document. In step S10, the user logs into the administration interface utilizing the user's digital certificate. In step S12, the verifying module 10 verifies the digital certificate and determines whether the digital certificate is valid, for example, the verifying module 10 determines whether the digital certificate is within the valid period. If the digital certificate is valid, in step S14, the displaying module 12 displays a corresponding list of legal documents that are responsible by the user, and the user selects one of the legal documents that need to be reviewed. Otherwise, if the digital certificate is not valid, the procedure ends.

In step S16, the setting module 11 sets the contact information of corresponding users related to the legal document, the related users including internal users and external users. In step S18, the term and condition entries of the legal document are reviewed by the user in detail. In step S20, the term and condition entries are determined whether to be agreeable. If the term and condition entry is not agreeable, in step S22, the negotiating module 13 provides the opinion-broadcast mode for the user to select, and the user reflects opinions through the negotiating module 13. Otherwise, if the term and condition entry is agreeable, the procedure directly goes to step S28.

In step 24, the informing module 14 informs the related users to view the opinions and to negotiate the term and condition entry. The related users may further respond to any opinions through the negotiating module 13.

In step S26, the negotiating module 13 modifies the term and condition entry according to all the opinions. After modifying the term and condition entry, all related users click the corresponding “agree” button, and the status of the term and condition entry is updated to be “agreeable” by the displaying module 12. In step S28, the user determines whether any term and condition entries needs to be reviewed according to the opinions. If no term and condition entries need to be reviewed, in step S30, the negotiating module 13 creates a finalized legal document that is ready to be signed by managers of the enterprise and the supplier without further disagreements. Otherwise, if there are still some term and condition entries that need to be reviewed, the procedure returns to step S18.

In alternative embodiments, the user may be one of the internal users or the external users.

FIG. 4 is a schematic diagram of the exemplary legal document. As shown in FIG. 4, the exemplary legal document has five main columns: a selection column 40, a term and condition entries column 42, a status column 44, a decision column 46, and an opinion column 48. The selection column 40 is configured for providing selection boxes for the related users to select any corresponding term and condition entries that needs to be negotiated. The term and condition entries column 42 is configured for recording all term and condition entries of the exemplary legal document. The status column 44 is configured for displaying the status of each term and condition entry. The decision column 46 is configured for providing the clickable buttons for the related users, such as the “agree” button to be clicked by the related users when the users agree with the corresponding term and condition entry. The opinion column 48 is configured for displaying opinions reflected by the related users.

The statuses of all the term and condition entries are defaulted to be “agreeable”. If related users disagree on any term and condition entries, the related users tick the corresponding selection boxes in the selection column 40, the status column 44 is updated to display “in negotiation” by the displaying modulel 2, and the decision column 46 is provided with the “agree” button to be clicked by the related users after negotiating and modifying corresponding term and condition entries as necessary.

It should be emphasized that the above-described embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for negotiating term and condition entries of a legal document, the system comprising:
a setting module configured for setting contact information of users related to the legal document;
a displaying module configured for displaying term and condition entries of the legal document, and for displaying a status of each term and condition entry; and
a negotiating module configured for reflecting opinions of the users on the term and condition entries, for modifying the term and condition entries according to the opinions, and for creating a finalized legal document.

2. The system as claimed in claim 1, further comprising a verifying module configured for providing a digital certificate for recording an identification of each user, for verifying the digital certificate, and for determining whether the digital certificate is valid.

3. The system as claimed in claim 2, wherein the verifying module is further configured for setting a valid period of the digital certificate.

4. The system as claimed in claim 1, further comprising an informing module configured for informing the related users to respond to the opinions by the contact information.

5. The system as claimed in claim 1, further comprising a storing module configured for storing the legal document, the term and condition entries, and the opinions.

6. The system as claimed in claim 1, wherein the displaying module is further configured for displaying a list of legal documents corresponding to the digital certificate.

7. The system as claimed in claim 1, wherein the negotiating module is further configured for limiting authorities of the related users.

8. The system as claimed in claim 1, wherein the contact information of the related users comprises e-mail addresses of the users.

9. The system as claimed in claim 1, wherein the status of each term and condition entry is updated in real time.

10. A method for negotiating term and condition entries of a legal document, the method comprising the steps of:
setting contact information of users related to the legal document;
displaying term and condition entries of the legal document;
reviewing the term and condition entries;
determining whether the term and condition entries are unanimously agreeable;
reflecting opinions corresponding to the term and condition entries if the term and condition entries are not agreeable;
informing the related users to negotiate the term and condition entries;
modifying the term and condition entries according to the opinions; and
creating a finalized legal document.

11. The method according to claim 10, further comprising the steps of:
logging into an administration interface;
inputting a digital certificate;
verifying the digital certificate;
determining whether the digital certificate is valid; and
selecting a legal document if the digital certificate is valid.

12. The method according to claim 10, further comprising the step of:
creating the finalized legal document if the term and condition entries are unanimously agreeable.

13. The method according to claim 10, wherein the displaying step further comprises the step of displaying a status of each term and condition entry.

14. The method according to claim 13, wherein the status of each term and condition entry is updated in real time.
